(19) United States
(12) Patent Application Publication
(10) Pub. No.: US 2026/0175573 A1
(43) Pub. Date: Jun. 25, 2026

(54) LIQUID EJECTION HEAD

(71) Applicant: CANON KABUSHIKI KAISHA, Tokyo (JP)

(72) Inventors: SOUTA TAKEUCHI, Kanagawa (JP); ATSUNORI TERASAKI, Kanagawa (JP)

(21) Appl. No.: 19/408,028

(22) Filed: Dec. 3, 2025

(30) Foreign Application Priority Data
Dec. 19, 2024 (JP) 2024-223877

(51) Int. Cl. B41J 2/14; B41J 2/16

(52) U.S. Cl. CPC B41J 2/14233; B41J 2/1433; B41J 2/162; B41J 2/1626; B41J 2/1642; B41J 2002/14419; B41J 2202/03

(57) ABSTRACT

A liquid ejection head includes a nozzle substrate including a plurality of nozzles, each including an ejection port for ejecting liquid, a flow path substrate including a plurality of individual flow paths and a common flow path, each individual flow path configured to supply the liquid to a respective nozzle of the plurality of nozzles, with the common flow path fluidly communicating with the plurality of individual flow paths, a multilayer substrate formed by laminating a plurality of substrates including the nozzle substrate and the flow path substrate, and a protective film formed of at least one material, the at least one material being continuously provided on an inner wall surface of a flow path extending from the common flow path to the ejection port, wherein the protective film is thicker in the common flow path than in the nozzle.

### BACKGROUND

### Field of the Technology

The present disclosure relates to a liquid ejection head.

### Description of the Related Art

Some inkjet recording heads, as an example of a liquid ejection head, include a multilayer substrate laminated with adhesive, the multilayer substrate being provided with flow paths including nozzle openings (ejection ports) for ejecting liquid. For example, piezoelectric actuators, which are piezoelectric elements, are provided on one side of the substrate provided with pressure chambers communicating with the ejection ports, and by driving the piezoelectric actuators, vibration plates are deformed to generate pressure changes in the pressure chambers, ejecting ink droplets from the ejection ports.

Japanese Patent Laid-Open No. 2014-124887 discloses a configuration that provides a protective film having liquid resistance on substrates made using silicon. In Japanese Patent Laid-Open No. 2014-124887, the protective film formed of at least one material selected from the group consisting of tantalum oxide, hafnium oxide, and zirconium oxide, formed by an atomic layer deposition method, is continuously provided on the inner walls of the flow paths.

Out of the flow paths provided in a multilayer substrate, a common flow path that fluidly communicates with a plurality of nozzles to supply liquid has a total liquid flow rate greater than that of a nozzle. Thus, a protective film is to be thick enough to achieve sufficient liquid resistance of the substrate including the common flow path.

Here, in the configuration discussed in Japanese Patent Laid-Open No. 2014-124887 where the protective film in uniform thickness is continuously provided on the inner walls of the flow paths from the common flow path to the nozzles, if the film thickness of the protective film is increased to enhance liquid resistance of the common flow path, the protective film at the nozzles and the ejection ports will be thicker. This may cause the opening width of ejection ports to be unstable or an ejection port to be clogged.

Further, in the multilayer substrate, if the protective film in the pressure chambers where the piezoelectric actuators are provided is made too thick, energy efficiency of the piezoelectric actuators will decrease.

### SUMMARY

In view of the above-described issues, the present disclosure is directed to providing a liquid ejection head that enhances liquid resistance of a common flow path having a high total liquid flow rate, enhancing reliability for liquid without degrading the ejection function of the ejection ports.

An aspect of the present disclosure provides a liquid ejection head that includes a nozzle substrate including a plurality of nozzles, each including an ejection port for ejecting liquid; a flow path substrate including a plurality of individual flow paths and a common flow path, each individual flow path configured to supply the liquid to a respective nozzle of the plurality of nozzles, with the common flow path fluidly communicating with the plurality of individual flow paths; a multilayer substrate formed by laminating a plurality of substrates including the nozzle substrate and the flow path substrate; and a protective film formed of at least one material, the at least one material being continuously provided on an inner wall surface of a flow path extending from the common flow path to the ejection port. The protective film is thicker in the common flow path than in the nozzle.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view of a liquid ejection apparatus. FIG. 1B is a perspective view of a liquid ejection head.

FIGS. 2A and 2B are perspective views illustrating a liquid ejection substrate according to a first embodiment of the present disclosure.

FIG. 3 is an enlarged cross-sectional view of a main part of the liquid ejection substrate according to the first embodiment of the present disclosure.

FIG. 4A is a diagram for describing a process for preparing a flow path substrate.

FIG. 4B is a diagram for describing a process for forming a protective film on the flow path substrate. FIG. 4C is a diagram for describing a process for preparing an actuator substrate. FIG. 4D is a diagram for describing a process for joining an actuator to the flow path substrate. FIG. 4E is a diagram for describing a process for forming a cavity and a penetration flow path in the actuator substrate. FIG. 4F is a diagram for a process for preparing a silicon-on-insulator (SOI) substrate. FIG. 4G is a diagram for describing a process for joining the SOI substrate to the actuator substrate. FIG. 4H is a diagram for describing a process for forming an ejection port. FIG. 4I is a diagram for describing a process for forming the protective film on the flow path substrate, the actuator substrate, and a nozzle substrate.

FIG. 5 is an enlarged cross-sectional view of a main part of a liquid ejection substrate according to a second embodiment of the present disclosure.

FIG. 6A is a diagram for describing a process for preparing a flow path substrate. FIG. 6B is a diagram for describing a process for forming a protective film on the flow path substrate. FIG. 6C is a diagram for describing a process for preparing an actuator substrate. FIG. 6D is a diagram for describing a process for joining an actuator to the flow path substrate. FIG. 6E is a diagram for describing a process for forming a cavity and a penetration flow path in the actuator substrate. FIG. 6F is a diagram for describing a process for forming the protective film on the flow path substrate and the actuator substrate. FIG. 6G is a diagram for describing a process for preparing an SOI substrate. FIG. 6H is a diagram for describing a process for joining the SOI substrate to the actuator substrate. FIG. 6I is a diagram for describing a process for forming an ejection port. FIG. 6J is a diagram for describing a process for forming the protective film on the flow path substrate, the actuator substrate, and a nozzle substrate.

FIG. 7 is an enlarged cross-sectional view of a main part of a liquid ejection substrate according to a third embodiment of the present disclosure.

FIG. 8A illustrates top and bottom views of a liquid ejection head. FIG. 8B is a schematic cross-sectional view of the liquid ejection head. FIG. 8C is a partial enlarged view of FIG. 8B.

FIG. 9A is a plan transparent view of a liquid ejection substrate. FIG. 9B is a cross-sectional view of FIG. 9A.

### DESCRIPTION OF THE EMBODIMENTS

Some embodiments of the present disclosure will now be described in detail with reference to the attached drawings. The embodiments described below are merely examples of the present disclosure, and are not intended to limit the scope of the present disclosure to those embodiments. Further, a liquid ejection head using a piezoelectric element will be described below as an example, but the present disclosure can also be applied to a liquid ejection head that uses a heating resistance element or an electrothermal conversion element. In addition, liquid to be ejected is not limited to ink as long as the liquid can be ejected from a liquid ejection head.

In the following description and drawings, a Z direction refers to a direction in which silicon substrates, which will be described below, are laminated or the depth direction of an individual flow path or a hole, which will be described below. The Z direction is also a direction in which liquid is ejected from an ejection port, which will be described below. A direction perpendicular to the Z direction is defined as an X direction. A direction perpendicular to both the Z direction and an X direction is defined as a Y direction. A diameter refers to a dimension in an XY plane, and a radial direction refers to a direction from the center axis to the outer periphery of a hole in the XY plane. For a circular cross-section hole or a through-hole, the diameter is equal to the diameter of the circular cross-section hole or the through-hole in the XY plane.

### (Liquid Ejection Apparatus)

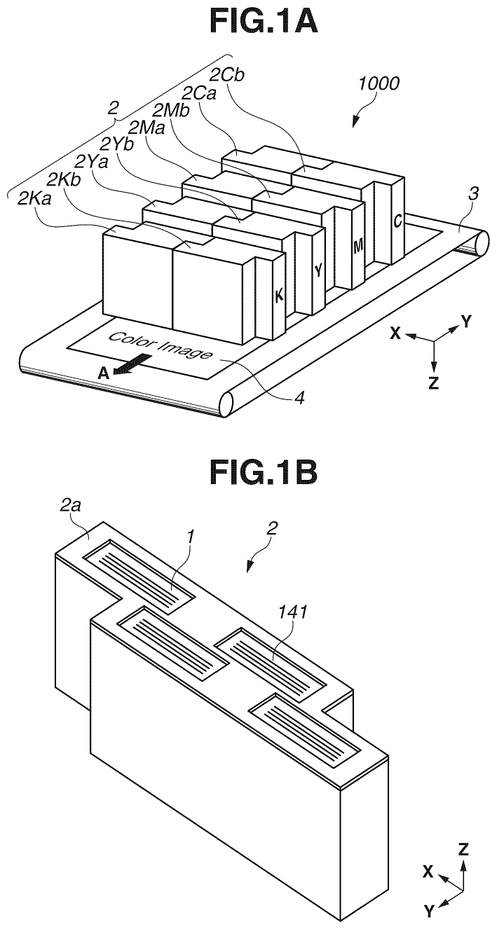

FIG. 1A is a schematic perspective view illustrating a general configuration of a liquid ejection apparatus 1000 according to a first embodiment of a liquid ejection apparatus to which the present disclosure can be applied.

The liquid ejection apparatus 1000 according to the present embodiment is a one-pass type configured to record an image on a recording medium 4 through a single movement of the recording medium 4, and ejection ports are arranged corresponding to the entire width of the recording medium 4. The liquid ejection apparatus 1000 includes a liquid ejection head 2, which is, for example, detachably attached.

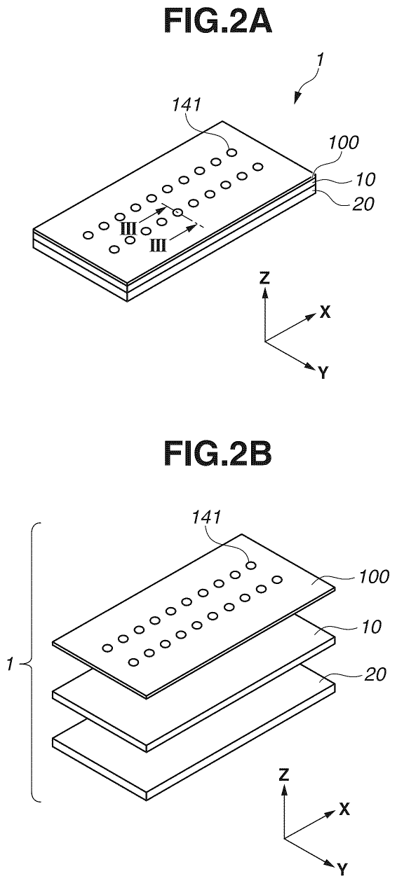

The recording medium 4 is conveyed by a conveyance unit 3 in a direction of arrow A, and the liquid ejection head 2 performs recording on the recording medium 4. In order to perform full-color recording, the liquid ejection head 2 including eight liquid ejection heads 2Ca, 2Cb, 2Ma, 2Mb, 2Ya, 2Yb, 2Ka, and 2Kb is used to eject liquid ink of cyan (C), magenta (M), yellow (Y), and black (K). When it is not necessary to distinguish between the liquid ejection heads for each color, the liquid ejection heads are collectively referred to as the liquid ejection head 2 herein. The liquid ejection head 2 according to the present disclosure can be implemented in forms such as the example illustrated in FIGS. 2A and 2B, and may also include other forms.

### (Configuration of Liquid Ejection Head)

FIG. 1B is a perspective view of the liquid ejection head 2 as an example to which the present disclosure can be applied. In the liquid ejection head 2, a plurality of liquid ejection substrates 1 each including nozzles 140 and ejection ports 141 is arranged on a liquid ejection head main body 2a. Ink to be ejected is supplied from a liquid tank to each liquid ejection substrate 1 via a common supply port of the liquid ejection head main body 2a.

### First Embodiment

### (Configuration of Liquid Ejection Substrate)

FIG. 2A is a perspective view of a liquid ejection substrate 1, and FIG. 2B is an exploded perspective view of the liquid ejection substrate 1 illustrated in FIG. 2A.

The liquid ejection substrate 1 according to a first embodiment is a multilayer substrate formed by laminating a nozzle substrate 100, an actuator substrate (an element substrate) 10, and a flow path substrate 20, in that order. The nozzle substrate 100, the actuator substrate 10, and the flow path substrate 20 according to the present embodiment are each formed of a silicon substrate. The nozzle substrate 100, the actuator substrate 10, and the flow path substrate 20 are joined with adhesive. An internal structure of the liquid ejection substrate 1, such as a flow path, is not illustrated in FIGS. 2A and 2B, to more clearly illustrate a multilayer structure of the liquid ejection substrate 1 and the ejection ports 141. The ejection ports 141 are formed in the nozzle substrate 100. A plurality of the ejection ports 141 is arranged in the X direction of the nozzle substrate 100 to form a nozzle row, and two nozzle rows are formed in the Y direction.

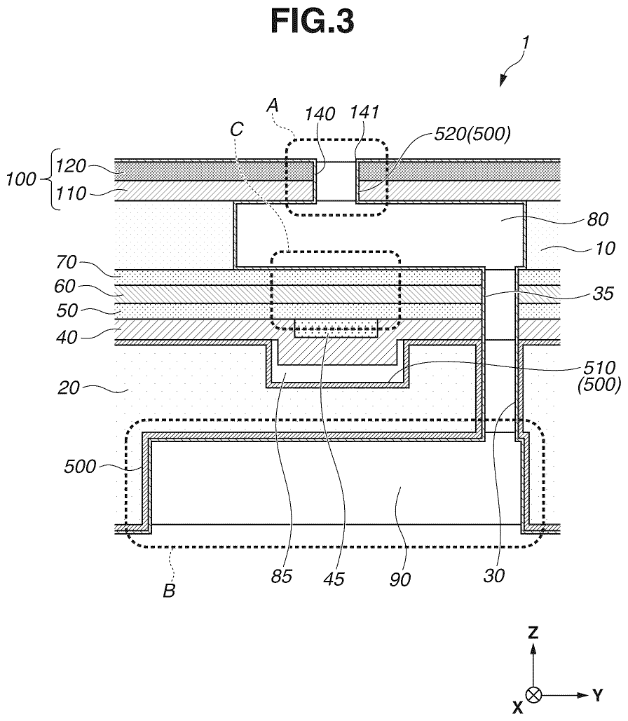

FIG. 3 is a cross-sectional view illustrating a main part of the liquid ejection substrate 1 according to the first embodiment taken along the line III-III of FIG. 2A.

The nozzle substrate 100 includes a silicon substrate 110 (also referred to as a silicon layer 110) and an insulation film 120, and has a nozzle 140 including an ejection port 141 therein. In the configuration according to the present embodiment, the nozzle 140 communicates with a cavity 80 in the actuator substrate 10.

The actuator substrate 10 has the cavity 80 that serves as a liquid chamber communicating with the nozzle 140 and supports a vibration film 60 via an insulation film 70. The vibration film 60 is provided with a piezoelectric element 45 on the opposite surface from the cavity 80 via an insulation film 50. The piezoelectric element 45 is covered with a protective film 40 on the opposite side from the insulation film 50. The insulation film 70 forms one surface of the cavity 80 and defines the cavity 80 together with silicon side walls of the actuator substrate 10 and the silicon substrate 110 of the nozzle substrate 100. Ink is supplied to the cavity 80 through a penetration flow path 35 that penetrates the protective film 40, the insulation film 50, the vibration film 60, and the insulation film 70 in the Z direction and an individual flow path 30 that penetrates the flow path substrate 20 in the Z direction.

The flow path substrate 20 includes a common supply flow path 90 that supplies ink to a plurality of the cavities 80. The common supply flow path 90 is provided extending in the Y direction (the horizontal direction in FIG. 3) so as to distribute ink supplied from outside the liquid ejection substrate 1 throughout the liquid ejection substrate 1. The common supply flow path 90 fluidly communicates with each of the cavities 80 via each of a plurality of the individual flow paths 30 arranged side by side in the Y direction (the horizontal direction in FIG. 3). Further, in the flow path substrate 20, a space for allowing the peripheries of the piezoelectric element 45 and the vibration film 60 to easily deform is formed by a cavity 85.

By applying a drive voltage from a power supply to the piezoelectric element 45 serving as an ejection element, the vibration film 60 is vibrated, expanding and contracting the cavity 80 repeatedly. Ink in the cavity 80 supplied from the common supply flow path 90 through the individual flow path 30 is pressurized and ejected from the ejection port 141 in the Z direction. In summary, ink supplied from outside the liquid ejection substrate 1 flows through the flow path from the common supply flow path 90 to the ejection port 141 to be ejected from the ejection port 141. In the configuration according to the present embodiment illustrated in FIG. 3, the flow path from the common supply flow path 90 to the ejection port 141 represents the flow path from the common supply flow path 90 through the individual flow path 30, the penetration flow path 35, and the cavity 80 to the nozzle 140.

In order to enhance liquid resistance of the common supply flow path 90 that has a high total liquid flow rate without degrading the ejection function of the ejection ports 141, the entire liquid ejection substrate 1 and the flow paths are covered with a protective film 500 having resistance to liquid to be ejected in the present embodiment. It is sufficient that the protective film 500 has resistance to the liquid to be ejected. The protective film 500 may be formed of at least one material selected from the group consisting of tantalum oxide, hafnium oxide, zirconium oxide, and titanium oxide. According to the present embodiment, tantalum oxide is selected.

The protective film 500 continuously covers the inner wall surfaces of the flow path from the above-described common supply flow path 90 to the ejection port 141. In other words, the protective film 500 is continuously provided on the flow paths of the flow path substrate 20, the actuator substrate 10, and the nozzle substrate 100. Thus, liquid resistance of the flow paths is enhanced at joints between members (substrates) constituting the liquid ejection substrate 1.

Further, the protective film 500 has a film thickness in the common supply flow path 90 (the film thickness in the section B in FIG. 3) that is greater than the film thickness in the nozzle 140 and the ejection port 141 (the film thickness in a section A in FIG. 3).

The protective film 500 formed in the section A having the ejection port 141 is not made too thick from the viewpoint of ejection impact, while the protective film 500 formed in a section B, which encompasses the common supply flow path 90, is made thicker to enhance liquid resistance of the common supply flow path 90. This makes it possible for the entire liquid ejection substrate 1 to enhance liquid resistance of the common flow path having a high total liquid flow rate without degrading the ejection function of the ejection ports 141, improving the reliability of the entire liquid ejection substrate 1.

### (Film Thickness of Protective Film)

It has been experimentally found that the film thickness of the protective film 500 is may be 20 nanometers (nm) or more from the viewpoint of liquid resistance. However, in the case of a multilayer structure in which a plurality of substrates is joined with adhesive as in the present embodiment, the mechanical strength of the protective film is also required. Thus, the film thickness of the protective film 500 is may be 50 nm or more. In the present embodiment, tantalum oxide, which exhibits high mechanical strength of the film due to the high purity and high density, is adopted as an example.

The film density of tantalum oxide is set to 7.5 to 8.5 grams per cubic centimeter (g/cm³).

Further, in the common supply flow path 90, when the thickness of the flow path substrate 20 is large and the height of the common supply flow path 90 is high, roughness, such as irregularities, may appear on the inner wall surfaces of the common supply flow path 90 due to the impact of etching processing at the time of forming the flow paths. Thus, the film thickness of the protective film 500 in the common supply flow path 90 is 80 nm or more, in order to prevent a pinhole from being formed in the protective film 500 in the common supply flow path 90.

Further, the film thickness of the protective film 500 formed in the section B in FIG. 3, i.e., in the common supply flow path 90, may be less than 160 nm. This configuration stabilizes the opening width of ejection ports 141, which facilitates achievement of consistent ejection performance.

Two factors affected by the film thickness of the protective film 500 will be described. The first factor relates to continuous coverage of the protective film 500, and the second factor relates to energy efficiency of the piezoelectric elements 45.

The continuous coverage of the protective film 500 will now be described as the first factor. According to the present embodiment, the protective film 500 is formed on the flow path 35 extending across a plurality of the substrates of the liquid ejection substrate 1, which is formed by stacking and joining the nozzle substrate 100, the actuator substrate 10, and the flow path substrate 20 in that order. Further, as described above, the film thicknesses of the protective film 500 are different in the vicinity of an ejection port 141 and in the vicinity of a common supply flow path 90. Thus, from the viewpoint of the need to stably and continuously cover the members (the substrates) with different covering film thicknesses, the difference in film thickness of the protective film 500 in the flow paths is to be small.

If the difference in film thickness of the protective film 500 in the flow paths between the adjacent substrates is three times or more, the resultant film stress also differs by three times or more, making occurrence of shear stress no longer negligible. Then, uneven deformation may occur at joints between the substrates, which can cause the protective film to be peeled off between the members. To prevent the protective film 500 from being peeled off between the jointed substrates, the difference in film thickness of the protective film 500 is to be minimized between the substrates. Specifically, the difference in film thickness is to be less than three times.

According to the present embodiment, the film thickness of the protective film 500 formed on the actuator substrate 10 and the nozzle substrate 100 is set to 40 nm, and the film thickness of the protective film 500 on the flow path substrate 20 is set to 100 nm, keeping the difference in film thickness of the protective film 500 between the substrates within about twice. This enhances the continuous coverage of the protective film 500 over the flow paths.

The energy efficiency of the piezoelectric elements 45 will now be described. By applying a drive voltage to a piezoelectric element 45, the corresponding vibration film 60 is vibrated, expanding and contracting the corresponding cavity 80 repeatedly, ejecting ink from an ejection port 141. Thus, high energy efficiency is required in transmitting ejection energy from the piezoelectric element 45 to the ink in the cavity 80. For example, in a case where a thick protective film 500 is formed in the cavity 80 near the piezoelectric element 45, the ejection performance, such as the amount of ejection or the initial speed, is reduced. Thus, to prevent reduction in the energy efficiency of a piezoelectric element 45, the film thickness of the protective film 500 formed on a vibration plate (the section C in FIG. 3), which is near the piezoelectric element 45 and is vibrated by driving of the piezoelectric element 45, is to be less than 160 nm.

The film thickness of the protective film 500 has been described. However, when the thicknesses of the protective film 500 formed on the inner wall surfaces of the flow paths from the common supply flow path 90 to the ejection port 141 are compared at “the section A”, “the section B”, and “the section C”, a comparison is made using an average film thickness at diameters of approximately 100 micrometers (m). To directly obtain the film thickness of each section, the film thickness of a target section can be directly measured using cross-sectional scanning electron microscope (SEM) or transmission electron microscope (TEM). Further, an indirect measurement method can also be used in which a flat portion on the same surface approximately 5 mm away from a target section is measured using ellipsometry or X-ray reflectometry (XRR).

### (Method for Manufacturing Liquid Ejection Head)

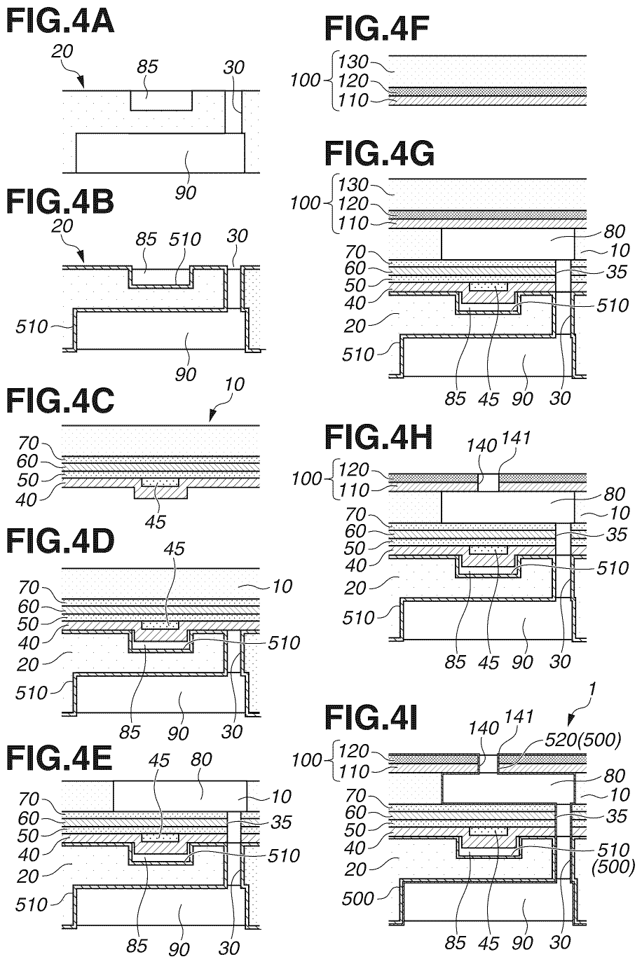

FIGS. 4A, 4B, 4C, 4D, 4E, 4F, 4G, 4H and 41 illustrate a method for manufacturing the liquid ejection substrate 1 according to the first embodiment illustrated in FIG. 3.

As described above, according to the present embodiment, the inner walls of the flow paths from the common supply flow path 90 to the ejection port 141 in the liquid ejection substrate 1 are continuously covered with the protective film 500 having resistance to liquid. Any method can be used to form the protective film 500. In view of coverage of joints between the members, and covering the front and back surfaces of the substrates and inside the flow paths, the protective film 500 is formed using an atomic layer deposition (ALD) method.

First, the common supply flow path 90 and the individual flow path 30 are formed in a silicon substrate by silicon etching or the like, and the flow path substrate 20 further provided with the cavity 85 is prepared (FIG. 4A). Subsequently, a protective film 510 is formed over the entire surface of the flow path substrate 20 including the wall surfaces of the flow path 30 using the ALD method (FIG. 4B). As an example, the protective film 510 according to the present embodiment is formed of tantalum oxide having a film thickness of 40 nm.

The actuator substrate 10 is prepared including the piezoelectric element 45 and the protective film 40 covering the piezoelectric element 45 over a silicon substrate which includes the insulation film 70, the vibration film 60, and the insulation film 50 (FIG. 4C), and is joined to the flow path substrate 20 (FIG. 4D).

The actuator substrate 10 can be provided with the protective film 40 in advance.

Next, the cavity 80 is formed in the actuator substrate 10 by silicon etching or the like, and the penetration flow path 35 connecting the cavity 80 to the individual flow path 30 in the flow path substrate 20 is formed (FIG. 4E).

Subsequently, an SOI substrate 100 formed of the silicon layer 110, a silicon oxide layer 120, and a silicon layer 130 is prepared as the nozzle substrate 100 (FIG. 4F) and is joined to the actuator substrate 10 (FIG. 4G).

The silicon layer 130 is then polished and removed until the silicon oxide layer 120 is exposed, and the nozzle 140 and the ejection port 141 are formed in the nozzle substrate 100 by silicon etching or the like (FIG. 4H).

Subsequently, a protective film 520 is further formed using the ALD method on the assembly of the flow path substrate 20, the actuator substrate 10 and the nozzle substrate 100 illustrated in FIG. 4I.

As an example, the protective film 520 according to the present embodiment is made of tantalum oxide having a film thickness of 60 nm. The liquid ejection head 2 is manufactured using the liquid ejection substrate 1 manufactured through the above-described processes.

By the above-described manufacturing processes, the thicknesses of the protective film 500 in the nozzle 140 and the ejection port 141 in the liquid ejection substrate 1 can be minimized while the protective film 500 in the common supply flow path 90 has a sufficient thickness. In the above-described example, the film thickness of the protective film 500 in the common supply flow path 90 (the film thickness of the protective film in the section B in FIG. 3) is 100 nm, which is the sum of the 40 nm-thick protective film 510 formed on the flow path substrate 20 and the 60 nm-thick protective film 520 formed over the entire liquid ejection substrate 1. On the other hand, the film thickness of the protective film in the nozzle 140 or the ejection port 141 (the film thickness of the protective film in the section A in FIG. 3) is limited only to the thickness of the 60 nm thick protective film 520 formed over the entire liquid ejection substrate 1.

In the cavity 85, which is a closed space during the formation of the protective film 520, the protective film 520 is not formed, so that the protective film 500 formed on the surface of the flow path substrate 20 is only the protective film 510 having a film thickness of 40 nm.

### Second Embodiment

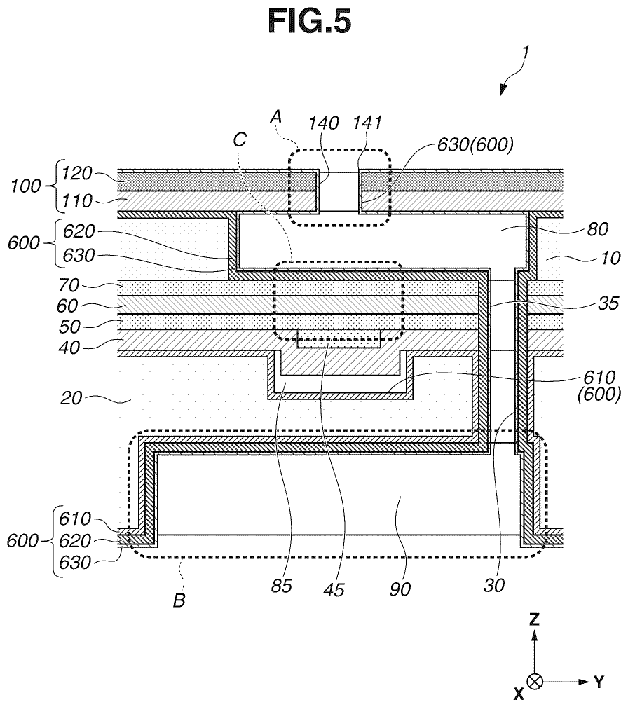

For conciseness, description of the parts that are the same or similar as those in the above-described first embodiment are incorporated by reference without being repeated. FIG. 5 is a cross-sectional view illustrating a configuration according to a second embodiment of the present disclosure. In the present embodiment, the entire liquid ejection substrate 1 and the flow paths are also covered with a protective film 600 having resistance to liquid.

Similar to the first embodiment, the film thickness of the protective film 600 in a common supply flow path 90 (the film thickness in the section B in FIG. 5) is greater than that in a nozzle 140 and an ejection port 141 (the film thickness in the section A in FIG. 5). Further, according to the present embodiment, the film thickness of the protective film 600 at “the section C” inside a cavity 80 near a piezoelectric element 45 (see FIG. 5) is also adjusted.

To prevent reduction in energy efficiency of the piezoelectric element 45, the protective film in “the section C”, which is inside the cavity 80 near the piezoelectric element 45 and serves as the operating area of an actuator when the piezoelectric element 45 is driven, is not to be too thick. From the viewpoint of vibration characteristics, the film thickness of the protective film 600 in “the section C” is to be less than 160 nm.

In addition, to prevent the protective film 600 from being peeled off between the substrates (a nozzle substrate 100, an actuator substrate 10, and a flow path substrate 20) that constitute a liquid ejection substrate 1, the difference in film thickness of the protective film 600 between the substrates is to be not too large. Specifically, the difference in film thickness of the protective film 600 between the substrates is to be less than three times.

Based on the above description, in the present embodiment, the film thickness of the protective film 600 in the sections A, B and C increases in the order of the section A, the section C, and the section B. The protective film 600 formed in the section A having the ejection port 141 is made not to be too thick from the perspective of ejection impact, and the protective film 600 formed in the section C is made not to be too thick from the perspective of the vibration characteristic, while the protective film 600 formed in the section B, which encompasses a common supply flow path 90, is made thicker to enhance liquid resistance of the common supply flow path 90. Consequently, the entire liquid ejection substrate 1 can enhance liquid resistance of the common supply flow path 90 having high total liquid flow rate without degrading the ejection function, improving reliability of the entire liquid ejection substrate 1. Further, the protective film 600 is configured in such a manner that its thickness increases in a step-by-step manner toward the common supply flow path 90 along the flow paths from the ejection port 141 to the common supply flow path 90. This configuration makes it possible to prevent both reduction in energy efficiency of the piezoelectric element 45 and improvement of the continuous coverage of the protective film 600, which further improve the reliability of the liquid ejection substrate 1.

According to the present embodiment, the film thickness of the protective film 600 is changed in each of the sections A, B, and C by changing the number of layers that form the protective film 600 covering the inner walls of the flow paths. Specifically, the protective film 600 in the section A has only a protective film 630, the protective film 600 in the section C has a protective film 610, a protective film 620, and the protective film 630, and the protective film 600 in the section B has the protective film 620 and the protective film 630. Further, the protective film 630, which can be put into contact with liquid flowing through the flow paths, continuously covers the inner walls of the flow paths within the liquid ejection substrate 1 from the common supply flow path 90 to the ejection port 141. This makes it possible to enhance liquid resistance of the flow path at joints between the members (the substrates) that form the liquid ejection substrate 1.

According to the present embodiment, the film thickness of the protective film 600 is set to 60 nm in the section A, 80 nm in the section C, and 100 nm in the section B, as an example.

### (Method for Manufacturing Liquid Ejection Head)

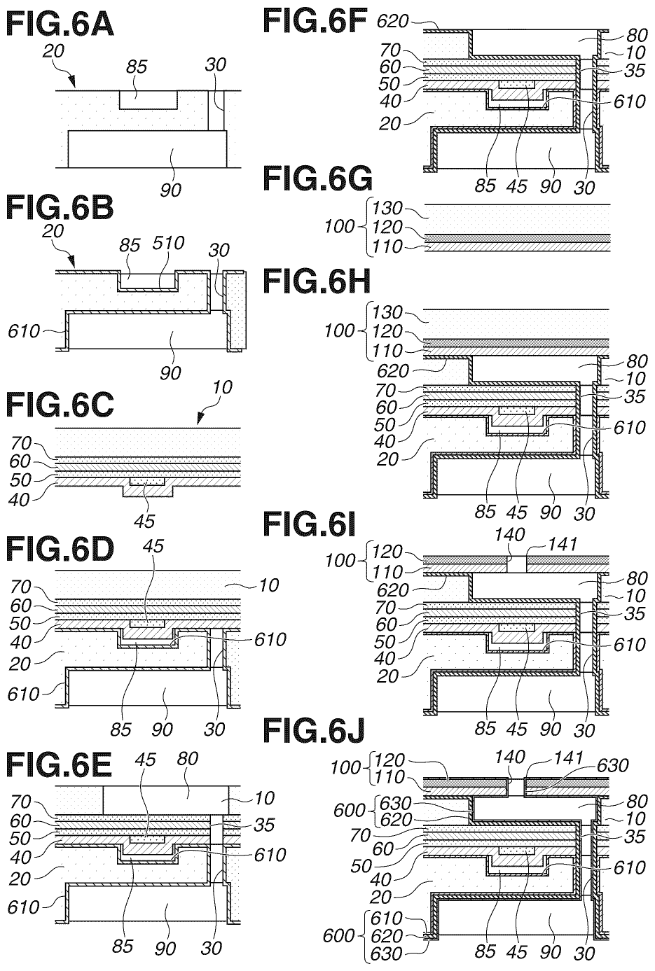

FIGS. 6A, 6B, 6C, 6D, 6E, 6F, 6G, 6H, 6I to 6J illustrate parts of the manufacturing processes for the liquid ejection substrate 1 according to the present embodiment.

First, the common supply flow path 90 and an individual flow path 30 are formed in a silicon substrate by silicon etching or the like, and the flow path substrate 20 further provided with the cavity 85 is prepared (FIG. 6A). Subsequently, the protective film 610 is formed over the entire surface of the flow path substrate 20 using the ALD method (FIG. 6B). As an example, the protective film 610 according to the present embodiment is made of tantalum oxide having a film thickness of 20 nm.

The actuator substrate 10 is prepared including the piezoelectric element 45 and the protective film 40 covering the piezoelectric element 45 over a silicon substrate which includes an insulation film 70, a vibration film 60, and an insulation film 50 (FIG. 6C), and is joined to the flow path substrate 20 (FIG. 6D).

Next, the cavity 80 is formed in the actuator substrate 10 by silicon etching or the like, and a penetration flow path 35 connecting the cavity 80 to the individual flow path 30 in the flow path substrate 20 is formed (FIG. 6E).

Subsequently, the protective film 620 is formed on the multilayer structure of the flow path substrate 20 and the actuator substrate 10 using the ALD method (FIG. 6F). As an example, the protective film 620 according to the present embodiment is made of tantalum oxide having a film thickness of 20 nm.

Next, the SOI substrate 100 formed of a silicon layer 110, a silicon oxide layer 120, and a silicon layer 130 is prepared as the nozzle substrate 100 (FIG. 6G) and is joined to the actuator substrate 10 (FIG. 6H).

The silicon layer 130 is then polished and removed, and the nozzle 140 and the ejection port 141 are formed in the nozzle substrate 100 by silicon etching or the like (FIG. 6I).

Subsequently, the protective film 630 is further formed using the ALD method on the assembly of the flow path substrate 20, the actuator substrate 10, and the nozzle substrate 100 (FIG. 6J).

As an example, the protective film 630 according to the present embodiment is made of tantalum oxide having a film thickness of 60 nm. The liquid ejection head 2 is manufactured using the liquid ejection substrate 1 manufactured through the above-described processes.

By the above-described manufacturing processes, the thickness of the protective film 600 in the nozzle 140 and the ejection port 141 in the liquid ejection substrate 1 can be minimized while the protective film in the common supply flow path 90 has a sufficiently thickness. In the above-described example, the film thickness of the protective film 600 in the common supply flow path 90 (the film thickness of the protective film 600 in the section B in FIG. 5) is 100 nm, which is the sum of the 20 nm-thick protective film 610 formed on the flow path substrate 20, the 20 nm-thick protective film 620 formed on the flow path substrate 20 and the actuator substrate 10, and the 60 nm-thick protective film 630 formed over the entire liquid ejection substrate 1. Further, the film thickness of the protective film 600 inside the cavity 80 near the piezoelectric element 45 (the film thickness of the protective film 600 in the section C in FIG. 5) is 80 nm, which is the sum of the 20 nm-thick protective film 620 and the 60 nm-thick protective film 630. Further, the film thickness of the protective film 600 in the nozzle 140 or the ejection port 141 (the film thickness of the protective film 600 in the section A in FIG. 5) is limited only to the thickness of the 60 nm-thick protective film 630 formed over the entire liquid ejection substrate 1.

During the formation of the protective films 620 and 630, on the cavity 85, which is a closed space, the protective film 620 is not formed, and thus, the protective film formed on the surface of the flow path substrate 20 is only the protective film 610 having a film thickness of 40 nm.

According to the present embodiment, a protective film is formed a plurality of times to change the film thickness in flow paths. Thus, the number of layers constituting the protective film 600 as a multilayer film, is three in the section B of the common flow path 90, which is greater than the two layers in the section C inside the cavity 80 and the one layer in the section A near the nozzle 140. In other words, the protective film 600 includes a multilayer film portion, and the number of layers constituting the multilayer protective film 600 is greater in the cavity 80 (the liquid chamber) than in the nozzle 140, and greater in the common flow path 90 than in the cavity 80.

### Third Embodiment

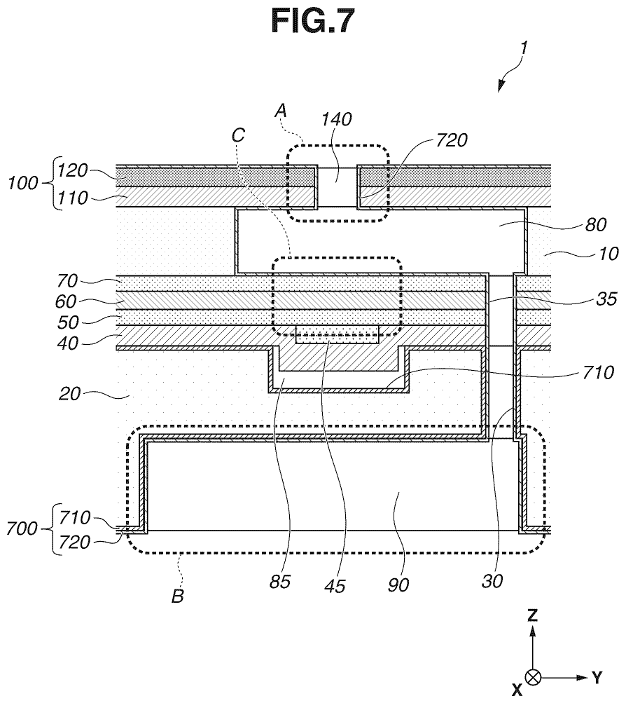

For conciseness, description of the parts that are the same as those in the above-described first and second embodiments are incorporated by reference without being repeated. FIG. 7 is a cross-sectional view illustrating a liquid ejection head 1 according to a third embodiment of the present disclosure. In the present embodiment, the entire liquid ejection substrate 1 and the flow paths are covered with a protective film 700 having resistance to liquid. The protective film 700 includes a protective film 710 that covers a flow path substrate 20 and a protective film 720 that continuously covers the flow paths.

In the protective film 700 according to the present embodiment, the film thickness in a common supply flow path 90 (the film thickness in the section B in FIG. 7) is greater than the film thickness in “the section C” inside a cavity 80 near a piezoelectric element 45. This prevents reduction in energy efficiency of the piezoelectric element 45 while enhancing the liquid resistance of the common supply flow path 90, which improves reliability of the liquid ejection substrate 1.

### Fourth Embodiment

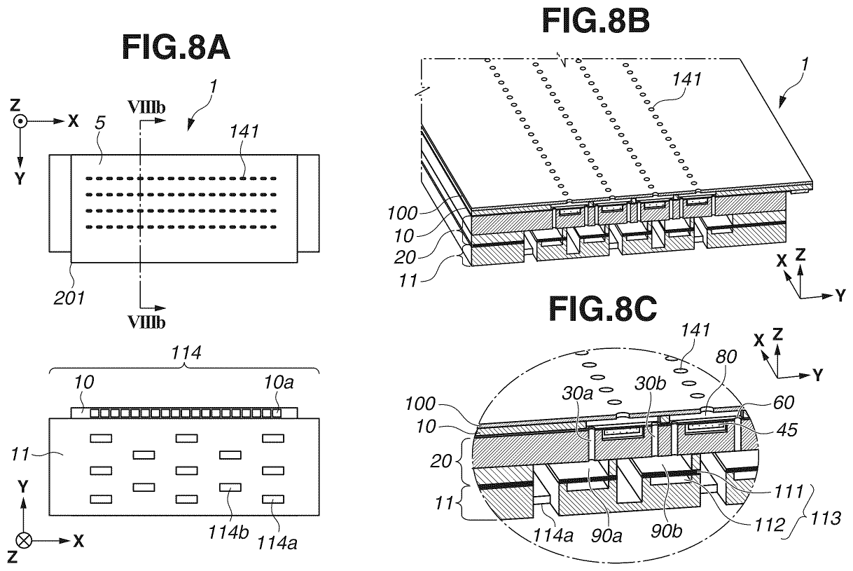

For conciseness, description of the parts that are the same as those in the above-described first to third embodiments are incorporated by reference without being repeated. The present disclosure can also be applied to a liquid ejection substrate where liquid circulates inside and outside a cavity 80, which is a pressure chamber that supplies liquid to a nozzle 140. FIG. 8A illustrates a liquid ejection substrate 1 of the liquid ejection head according to a fourth embodiment of the present disclosure as viewed from the surface on which the nozzles are arranged and as viewed from the opposite surface from the surface on which the nozzles are arranged. FIG. 8B is a schematic cross-sectional view taken along the line VIIIb-VIIIb in FIG. 8A. FIG. 8C is a partially enlarged view of FIG. 8B. The liquid ejection substrate 1 is composed of four substrates: a nozzle substrate 100, an actuator substrate 10, a flow path substrate 20, and a damper substrate 11. The actuator substrate 10 includes liquid chambers 80, vibration films 60, and piezoelectric elements 45. The flow path substrate 20 has grooves that serve as voids surrounding individual flow paths 30, common flow paths 90, and the piezoelectric elements 45. The damper substrate 11 includes damper films 111, damper chambers 112, and common openings 114. Ink is supplied from the common openings 114 formed on the damper substrate 11 to the nozzle substrate 100 via the flow path substrate 20 and is ejected from ejection ports 141 to be applied to the recording medium 4 (see FIG. 1A). In the liquid ejection head 2, an electric circuit board is disposed to supply electricity and signals necessary for ejecting liquid, and is connected to each terminal 10a on the liquid ejection substrate 1 via wiring.

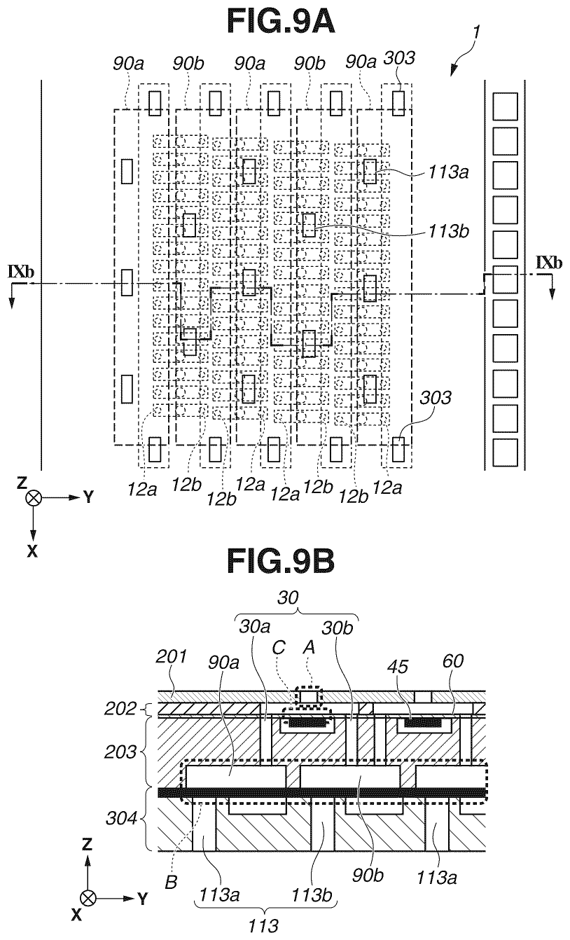

FIG. 9A is an enlarged plan transparent view of a portion of the liquid ejection substrate 1 related to the liquid ejection head of the present disclosure, as viewed from the opposite surface from the surface on which the ejection ports 141 are arranged. FIG. 9B is a cross-sectional view taken along a line IXb-IXb in FIG. 9A. As illustrated in FIG. 9A, the liquid ejection substrate 1 according to the present embodiment includes a plurality of nozzle rows arranged in the X direction, and a nozzle row includes, as a structure unit, the ejection port 141, the nozzle 140, the liquid chamber (the pressure chamber) 80, the individual flow path 30 that communicates with the liquid chamber 80, and the piezoelectric element 45 that generates pressure in the liquid chamber 80. As illustrated in FIG. 9B, a piezoelectric element 45 for ejecting liquid by pressure is disposed at a position corresponding to each ejection port 141. In each nozzle row, an individual supply flow path 30a and an individual collection flow path 30b, both of which form the individual flow path 30, respectively extend on one side and the other side. The individual supply flow paths 30a and the individual collection flow paths 30b are flow paths that are provided on the liquid ejection substrate 1 and extend in the Z direction, and each flow path communicates with a corresponding nozzle 140. Further, an individual supply flow path 30a and an individual collection flow path 30b are each connected to the corresponding common flow path 90 that includes a common supply flow path 90a and a common collection flow path 90b. Connection points between the individual supply flow path 30a and the common supply flow path 90a, and the individual collection flow path 30b and the common collection flow path 90b are individual openings. A damper structure 113 that includes a damper chamber 112 and a damper film 111 is formed on a surface facing the surface having the individual openings. The common opening 114, which includes a common supply opening 114a and a common collection opening 114b respectively connected to the common supply flow path 90a and the common collection flow path 90b, is formed in the damper substrate 11 on which the damper structure 113 is formed. The common supply flow path 90a and the common collection flow path 90b are formed to extend in the X direction, which is a direction along the nozzle rows, on the opposite surface from the ejection surface with respect to the piezoelectric elements 45 in the Z direction in which liquid is ejected.

In the liquid ejection substrate 1 illustrated in FIGS. 9A and 9B, the liquid chamber 80 corresponding to each piezoelectric element 45 in each nozzle row has a length of 110 μm in the X direction. The liquid chambers 80 and the ejection ports 141 are arranged at intervals of 150 dots per inch (dpi). Further, by staggering such nozzle rows in the X direction to form four rows, a high-density nozzle arrangement of 600 dpi can be achieved for a recording medium. According to the present embodiment, the nozzle rows are configured as four rows to achieve a resolution of 600 dpi. However, the present disclosure is not limited to this configuration, and the nozzle rows may be arranged as eight to achieve a resolution of 1,200 dpi.

A liquid flow within the liquid ejection substrate 1 will now be described. When liquid is supplied to a common supply opening 114a, the liquid flows through the corresponding common supply flow path 90a and passes through the corresponding individual supply flow path 30a of each element, the corresponding liquid chamber 80, the corresponding nozzle 140, the corresponding individual collection flow path 30b, and the corresponding common collection flow path 90b to the corresponding common collection opening 114b. With this configuration, the liquid supplied from the common supply opening 114a can flow through the common collection opening 114b to be collected. By applying a differential pressure to the liquid flowing through the common supply opening 114a and the common collection opening 114b using a pump or a hydraulic head from the outside, the liquid can be circulated.

In a configuration where liquid circulates as described above in the present embodiment, the total flow rate of the liquid flowing through the flow path substrate 20 increases. Thus, the liquid resistance of the common flow path 90 (the common supply flow path 90a and the common collection flow path 90b) in the flow path substrate 20 is enhanced, and the present disclosure, which has increased reliability, can be employed. In the present embodiment, the entire liquid ejecting substrate 1 and the flow paths are covered with a protective film having resistance to liquid. Specifically, the protective film is continuously provided on the inner wall surfaces of the flow paths from the corresponding common flow path 90 to the corresponding ejection port 141 via the corresponding liquid chamber 80. In FIGS. 8A to 8C, and 9A, and 9B, the protective film is omitted. As in the second embodiment, the film thickness of the protective film in the flow paths is set to values having the relationship of the section B being greater than the section C, which is greater than the section A.

### OTHER EMBODIMENTS

The configuration according to the present disclosure is not limited to the above-described embodiments, and can be applied to various configurations of liquid ejection substrates.

For example, according to the above-described embodiments, the liquid ejection substrate 1 has the configuration in which the flow path substrate 20, the actuator substrate 10, and the nozzle substrate 100 are laminated, but it is not limited to that configuration as long as the configuration includes the common flow paths and the nozzles. For example, another substrate may be disposed between the nozzle substrate 100 and the actuator substrate 10. Further, a flow path substrate having a common flow path that communicates with a plurality of nozzles or a plurality of cavities serving as pressure chambers may be disposed between a nozzle substrate including the nozzles and an actuator substrate including piezoelectric elements. Furthermore, common flow paths and piezoelectric elements may be formed in the same substrate.

According to the above-described embodiments, the flow path substrate 20, the actuator substrate 10, and the nozzle substrate 100 are formed of silicon substrates, but those substrates may be formed of materials other than silicon, such as resin and metal. In this case, the material of the protective film that covers the inner wall surfaces of the flow paths can be selected based on the material of the substrates or the type of the liquid flowing through the flow paths.

In each of the above-described embodiments, the film thickness in the flow paths is changed by forming the protective film a plurality of times. However, the protective film, which is continuously provided on the inner wall surfaces of the flow paths from the common flow path to the ejection port and has a film thickness in the common flow path greater than that in the nozzle, can be provided through a single film formation process. Further, the protective film may be a multilayer film including films made of different materials.

According to the above-described embodiments, in a direction perpendicular to a surface of the liquid ejection substrate 1, the thickness of the actuator substrate 10 is greater than the thickness of the nozzle substrate 100, and the thickness of the flow path substrate 20 is greater than the thickness of the actuator substrate 10 in the multilayer configuration. However, the relationship between the thicknesses of the substrates is not limited to this relationship.

Further, according to the above-described embodiments, as a pressure generation unit for ejecting droplets from an ejection port 141, a thin-film type piezoelectric element is described, but the pressure generation unit is not specifically limited to this. Examples of actuators that can be used include a thick-film type piezoelectric actuator formed using a method of applying a green sheet, and a longitudinal vibration type piezoelectric actuator formed by alternately laminating a piezoelectric material and an electrode-forming material to perform expansion and contraction in an axial direction. Further, as the pressure generation unit, it is possible to use a heating element arranged inside a pressure chamber to eject droplets from a nozzle opening by using bubbles generated by heat from the heating element, or an electrostatic actuator, which generates static electricity between a vibrating plate and an electrode and deforms the vibration plate by electrostatic force to eject droplets from the nozzle opening, and the like.

### Technical Features of Present Disclosure

The present disclosure includes the following configurations and methods.

### EXAMPLES

The present disclosure will now be described in further detail using examples according to the present disclosure. However, the present disclosure is not limited to the following examples.

### First Example

In a first example, the liquid ejection substrate 1 illustrated in FIG. 3 was used. The thickness of the flow path substrate 20 is set to 600 μm, the thickness of the actuator substrate 10 is set to 100 μm, and the thickness of the nozzle substrate 100 is set to 20 μm. The hole diameter of an ejection port 141 is set to φ10 μm. Tantalum oxide was used for the protective film 500 (the protective films 510 and 520).

Liquid ejection substrates 1 were fabricated that had the configurations indicated in Table 1 as experimental examples 1-1 to 1-9. For these liquid ejection substrates 1, a water-soluble pigment ink with a potential of hydrogen (pH) of approximately 8 to 9 was used as the ejection liquid, and liquid resistance, print stability, and energy efficiency were evaluated. Further, the continuous coverage of the protective film 500 in the flow paths inside the liquid ejection substrate 1 was evaluated. The evaluation results were represented using symbols ∘, Δ, ▴, and x in the order from best to worst. Based on the above-described evaluation items, the overall evaluation was conducted in accordance with the following criteria.
A: All the four evaluation items are rated as ∘.
B: Δ is included in the four evaluation items.
C: ▴ is included in the four evaluation items.

The evaluation results are shown in Table 1.

TABLE 1

| | Film Thickness [nm] | | | | | Protective | | | | | |
|---|---|---|---|---|---|---|---|---|---|---|---|
| | | | Protective | Protective | Protective | Film | | | | | |
| | Protective | Protective | Film 500 | Film 500 | Film 500 | Maximum | Liquid | | Energy | Continuous | Overall |
| Example | Film 510 | Film 520 | Section A | Section C | Section B | Thickness | Resistance | Printing | Efficiency | Coverage | Evaluation |
| 1-1 | 40 | 60 | 60 | 60 | 100 | 1.7 | ∘ | ∘ | ∘ | ∘ | A |
| 1-2 | 80 | 60 | 60 | 60 | 140 | 2.3 | ∘ | ∘ | ∘ | Δ | B |
| 1-3 | 120 | 60 | 60 | 60 | 180 | 3.0 | ∘ | ∘ | ∘ | [symbol] | C |
| 1-4 | 40 | 100 | 100 | 100 | 140 | 1.4 | ∘ | ∘ | ∘ | ∘ | A |
| 1-5 | 120 | 100 | 100 | 100 | 220 | 2.2 | ∘ | ∘ | ∘ | Δ | B |
| 1-6 | 200 | 100 | 100 | 100 | 300 | 3.0 | ∘ | ∘ | ∘ | [symbol] | C |
| 1-7 | 40 | 160 | 160 | 160 | 200 | 1.3 | ∘ | Δ | Δ | ∘ | B |
| 1-8 | 180 | 160 | 160 | 160 | 340 | 2.1 | ∘ | Δ | Δ | Δ | B |
| 1-9 | 320 | 160 | 160 | 160 | 480 | 3.0 | ∘ | Δ | Δ | [symbol] | C |

In a second example, the liquid ejection substrate 1 illustrated in FIG. 5 was used. The thickness of the flow path substrate 20 is set to 600 μm, the thickness of the actuator substrate 10 is set to 100 μm, and the thickness of the nozzle substrate 100 is set to 20 μm. The hole diameter of an ejection port 141 is set to φ10 μm. Tantalum oxide was used for the protective film 600 (the protective films 610, 620, and 630).

Liquid ejection substrates 1 were fabricated that had the configurations indicated in Table 2 as experimental examples 2-1 to 2-9. For these liquid ejection substrates 1, a water-soluble pigment ink with a pH of approximately 8 to 9 was used as the ejection liquid, and ink resistance, print stability, and energy efficiency were evaluated. Further, the continuous coverage of the protective film 600 in the flow paths inside the liquid ejection substrate 1 was evaluated. Based on the above-described evaluation items, the overall evaluation was conducted in accordance with the same criteria as those in the example 1. The evaluation results are shown in Table 2.

TABLE 2

| | Film Thickness [nm] | | | | | | | | | | | |
|---|---|---|---|---|---|---|---|---|---|---|---|---|
| | | | | Pro- | Pro- | Pro- | | | | | | |
| | | | | tective | tective | tective | Pro- | | | | | |
| | Pro- | Pro- | Pro- | Film | Film | Film | tective | | | | | |
| | tective | tective | tective | 600 | 600 | 600 | Film | Liquid | | Energy | | Overall |
| | Film | Film | Film | Section | Section | Section | Maximum | Resis- | | Effi- | Continuous | Evalu- |
| Example | 610 | 620 | 630 | A | C | B | Thickness | tance | Printing | ciency | Coverage | ation |
| 2-1 | 20 | 20 | 60 | 60 | 80 | 100 | 1.3 | ∘ | ∘ | ∘ | ∘ | A |
| 2-2 | 40 | 40 | 60 | 60 | 100 | 140 | 1.7 | ∘ | ∘ | ∘ | ∘ | A |
| 2-3 | 60 | 60 | 60 | 60 | 120 | 180 | 2.0 | ∘ | ∘ | ∘ | ∘ | A |
| 2-4 | 20 | 20 | 100 | 100 | 120 | 140 | 1.2 | ∘ | ∘ | ∘ | ∘ | A |
| 2-5 | 60 | 60 | 100 | 100 | 160 | 220 | 1.6 | ∘ | ∘ | Δ | ∘ | B |
| 2-6 | 100 | 100 | 100 | 100 | 200 | 300 | 2.0 | ∘ | ∘ | [symbol] | Δ | C |
| 2-7 | 20 | 20 | 160 | 160 | 180 | 200 | 1.1 | ∘ | Δ | Δ | ∘ | B |
| 2-8 | 90 | 90 | 160 | 160 | 250 | 340 | 1.6 | ∘ | Δ | [symbol] | ∘ | C |
| 2-9 | 160 | 160 | 160 | 160 | 320 | 480 | 2.0 | ∘ | Δ | [symbol] | Δ | C |

In the experimental examples of the first and second examples shown in Tables 1 and 2, there is no result that exhibited significantly poor liquid resistance. Regarding the print stability, slight instability was observed in the experimental examples 1-7 to 1-9 and 2-7 to 2-9, where the film thickness of the protective film 500 in the section A is thick. Regarding the energy efficiency, the experimental examples 1-7 to 1-9 and 2-5 to 2-9, where the film thickness of the protective film 500 in the section C is greater, show lower efficiency than the other experimental examples. Especially, the experimental examples 2-6, 2-8, and 2-9, which have thick films, show low efficiency. Regarding the continuous coverage of the protective film, peel-off of the protective layers between the substrates was observed in the experimental examples 1-3, 1-6, and 1-9, which have large differences in film thickness between the substrates.

According to the present disclosure, a liquid ejection head can be provided that enhances liquid resistance of a common flow path having high total liquid flow rate without degrading the ejection function of ejection ports, improving reliability for liquid.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-223877, filed Dec. 19, 2024, which is hereby incorporated by reference herein in its entirety.

What is claimed is:

1. A liquid ejection head comprising:
a nozzle substrate including a plurality of nozzles, each including an ejection port for ejecting liquid;
a flow path substrate including a plurality of individual flow paths and a common flow path, each individual flow path configured to supply the liquid to a respective nozzle of the plurality of nozzles, with the common flow path fluidly communicating with the plurality of individual flow paths;
a multilayer substrate formed by laminating a plurality of substrates including the nozzle substrate and the flow path substrate; and
a protective film formed of at least one material, the at least one material being continuously provided on an inner wall surface of a flow path extending from the common flow path to the ejection port, wherein the protective film is thicker in the common flow path than in the nozzle.

2. A liquid ejection head comprising:
a nozzle substrate including a plurality of nozzles, each including an ejection port for ejecting liquid;
an element substrate including a pressure chamber configured to supply the liquid to the nozzle and an ejection element configured to eject the liquid from the ejection port;
a flow path substrate including a plurality of individual flow paths and a common flow path, each individual flow path configured to supply the liquid to a respective pressure chamber, with the common flow path fluidly communicating with the plurality of individual flow paths;
a multilayer substrate formed by laminating a plurality of substrates including the nozzle substrate, the element substrate, and the flow path substrate, in that order; and
a protective film formed of at least one material, the at least one material being continuously provided on an inner wall surface of a flow path extending from the common flow path to the ejection port via the pressure chamber,
wherein the protective film is thicker in the common flow path than in the pressure chamber.

3. The liquid ejection head according to claim 1,
wherein the multilayer substrate includes an element substrate including a pressure chamber configured to be supplied with the liquid from a corresponding individual flow path of the plurality of individual flow paths and to supply a corresponding nozzle of the plurality of nozzles with the liquid, and an ejection element configured to eject liquid from the ejection port,
wherein the protective film is continuously provided on the inner wall surface of the flow path including the pressure chamber, and
wherein the protective film is thicker in the common flow path than in the pressure chamber.

4. The liquid ejection head according to claim 3, wherein the protective film is thicker in the pressure chamber than in the nozzles.

5. The liquid ejection head according to claim 1, wherein the nozzle substrate and the flow path substrate are each formed of a silicon substrate.

6. The liquid ejection head according to claim 1, wherein a difference in thickness of the protective film between the nozzle substrate and the flow path substrate, the nozzle substrate and the flow path substrate being adjacent to each other, is less than three times.

7. The liquid ejection head according to claim 2, wherein the element substrate is thicker than the nozzle substrate, and the flow path substrate thicker than the element substrate, in a direction perpendicular to a surface of the multilayer substrate.

8. The liquid ejection head according to claim 1, wherein the nozzle substrate, the flow path substrate, and the multilayer substrate are joined together with an adjacent at least one of the nozzle substrate, the flow path substrate, and the multilayer substrate, by adhesive.

9. The liquid ejection head according to claim 1, wherein at least a portion of the protective film is a multilayer film.

10. The liquid ejection head according to claim 9, wherein the multilayer film has a greater number of layers in the common flow path than in the plurality of nozzles.

11. The liquid ejection head according to claim 3,
wherein at least a portion of the protective film is a multilayer film, and
wherein the multilayer film has a greater number of layers in the pressure chamber than in the nozzles, and a greater number of layers in the common flow path than in the pressure chamber.

12. The liquid ejection head according to claim 1, wherein thickness of the protective film in the common flow path is 80 nanometers (nm) or more.

13. The liquid ejection head according to claim 1, wherein thickness of the protective film in the plurality of nozzles is less than 160 nm.

14. The liquid ejection head according to claim 2, wherein thickness of the protective film in the pressure chamber is less than 160 nm.

15. The liquid ejection head according to claim 1, wherein the at least one material is selected from the group consisting of tantalum oxide, hafnium oxide, and zirconium oxide.

16. The liquid ejection head according to claim 2, wherein the at least one material is selected from the group consisting of tantalum oxide, hafnium oxide, and zirconium oxide.
